(19) United States
(12) Patent Application Publication
(10) Pub. No.: US 2025/0252116 A1
(43) Pub. Date: Aug. 7, 2025

(54) SYSTEMS AND METHODS FOR SYNCHRONIZING NON-FUNGIBLE TOKEN LEDGERS

(71) Applicant: DK Crown Holdings Inc., Boston, MA (US)

(72) Inventors: Brett Cain Weiss, II, West Creek, NJ (US); Nicola Atorino, Malta (IT); Ethan Haskell, Boston, MA (US); Andrew John Botelho, Norton, MA (US)

(73) Assignee: DK Crown Holdings Inc., Boston, MA (US)

(21) Appl. No.: 18/430,048

(22) Filed: Feb. 1, 2024

(51) Int. Cl. G06F 16/27; A63F 13/79; G06F 16/23

(52) U.S. Cl. CPC G06F 16/27; A63F 13/79; G06F 16/2379

(57) ABSTRACT

Described herein are systems and methods for synchronizing non-fungible token ledgers. The system can maintain a plurality of player profiles, with a first player profile identifying a plurality of non-fungible tokens maintained on a blockchain network. The system can provide a graphical user interface for display, including a plurality of slots corresponding to a first discard combination. The system can receive a request from a client device to discard a subset of the plurality of non-fungible tokens, with the subset corresponding to the plurality of slots. The system can determine that each non-fungible token of the subset satisfies a respective criteria of a respective slot of the plurality of slots. In response to determining that each non-fungible token of the subset satisfies the respective criteria of the respective slot, the system can store a respective identifier of each non-fungible token of the subset in a discard data structure.

### BACKGROUND

Non-fungible tokens (NFTs) are stored on a blockchain. Performing various operations for client devices may involve modifying the NFTs stored on the blockchain. When serving a large number of mobile devices, accessing the blockchain to perform the operations can be computationally expensive, involving large amounts of time and processing power.

### SUMMARY

The inherent immutability of NFTs can present challenges in modifying NFTs. Modifying NFTs, for example, including updating metadata or transferring ownership, can be computationally expensive, demanding excessive bandwidth and power consumption because each update to an NFT requires consensus on the blockchain network. This inevitably leads to network congestion and processing delays, making it impracticable to update large numbers of NFTs or to update NFTs in real-time or near real-time. Over time, certain attributes of NFTs may become outdated (or may need to be changed). The immutability of NFTs can make it difficult to update the outdated metadata or attributes stored on the blockchain, which can lead to the storage and maintenance of obsolete NFTs. Additionally, this maintenance issue may burden computer resources for both system administrators and users. Furthermore, accessing and modifying NFTs during transfers can lead to latency issues, as users may experience delays in interacting with the blockchain. This can hinder real-time processing and affect the user experience.

The systems and methods of this technical solution address these issues by maintaining a synchronized copy of NFT metadata associated with the NFTs. For example, the system can maintain a separate, synchronized storage system that can handle frequent metadata updates without directly modifying the NFTs on the blockchain. The system can use the off-chain storage to streamline NFT-related operations, such as compiling a list of NFTs for processing or updating, which reduces the computational overhead and network congestion generally associated with frequent individual transfers. Additionally, the system can implement scheduled batch blockchain operations to periodically update the blockchain with an aggregated list of operations generated using the off-chain storage system. This approach can optimize network efficiency by consolidating multiple operations into a single batch transfer/blockchain operation. The technical solution described herein can incorporate mechanisms to reflect the modifications made to the NFTs in the off-chain storage system without requiring computationally expensive blockchain operations, ensuring that users receive an up-to-date view of their NFTs, thereby improving the user experience and reducing latency in NFT updates.

One aspect of the present disclosure relates to a system for synchronizing NFT ledgers. The system can include one or more processors coupled to memory. The one or more processors may maintain a plurality of player profiles, with a first player profile of the plurality of player profiles identifying a plurality of non-fungible tokens maintained on a blockchain network. The one or more processors may provide, to a client device associated with the first player profile, a graphical user interface for display, including a plurality of slots corresponding to a first discard combination. The one or more processors may receive, from the client device, a request to discard a subset of the plurality of non-fungible tokens, the subset corresponding to the plurality of slots. The one or more processors may determine that each non-fungible token of the subset satisfies a respective criteria of a respective slot of the plurality of slots. In response to determining that each non-fungible token of the subset satisfies the respective criteria of the respective slot of the plurality of slots, the one or more processors may store a respective identifier of each non-fungible token of the subset in a discard data structure.

In some implementations, the one or more processors may execute, based on the discard data structure, a transfer via the blockchain network to discard the subset of the plurality of non-fungible tokens.

In some implementations, the one or more processors may execute the transfer to update associate each of the subset of the plurality of non-fungible tokens with a predetermined burn address of the blockchain network.

In some implementations, the one or more processors may execute the transfer at a predetermined time period or upon determining that a threshold number of non-fungible tokens are identified in the discard data structure.

In some implementations, the one or more processors may update the first player profile with an additional association with an additional non-fungible token responsive to determining that each non-fungible token of the subset satisfies the respective criteria of the respective slot of the plurality of slots.

In some implementations, the one or more processors may update the first player profile to remove respective associations with the subset of the plurality of non-fungible tokens.

In some implementations, the one or more processors may update the discard data structure with one or more respective second identifiers of one or more second non-fungible tokens identified in a second request received from a second client device.

In some implementations, the one or more processors may maintain respective metadata for each of the plurality of non-fungible tokens in a storage system.

In some implementations, the one or more processors may determine that each non-fungible token of the subset satisfies the respective criteria of the respective slot of the plurality of slots based on the respective metadata for the non-fungible token. In some implementations, the respective metadata may include at least one of a rarity value, an edition number, a sport identifier, a team identifier, an athlete identifier, or a time period identifier.

At least one aspect of the present disclosure is directed to a method of synchronizing NFT ledgers. The method can include maintaining a plurality of player profiles, with a first player profile of the plurality of player profiles identifying a plurality of non-fungible tokens maintained on a blockchain network. The method can include providing, to a client device associated with the first player profile, a graphical user interface for display comprising a plurality of slots corresponding to a first discard combination. The method can include receiving, from the client device, a request to discard a subset of the plurality of non-fungible tokens, the subset corresponding to the plurality of slots. The method can include determining that each non-fungible token of the subset satisfies a respective criteria of a respective slot of the plurality of slots. In response to determining that each non-fungible token of the subset satisfies the respective criteria of the respective slot of the plurality of slots, the method can include storing a respective identifier each non-fungible token of the subset in a discard data structure.

The method can include executing, based on the discard data structure, a transfer via the blockchain network to discard the subset of the plurality of non-fungible tokens.

The method can include executing the transfer to update associate each of the subset of the plurality of non-fungible tokens with a predetermined burn address of the blockchain network.

The method can include executing the transfer at a predetermined time period or upon determining that a threshold number of non-fungible tokens are identified in the discard data structure.

The method can include updating the first player profile with an additional association with an additional non-fungible token responsive to determining that each non-fungible token of the subset satisfies the respective criteria of the respective slot of the plurality of slots.

The method can include updating the first player profile to remove respective associations with the subset of the plurality of non-fungible tokens.

The method can include updating the discard data structure with one or more respective second identifiers of one or more second non-fungible tokens identified in a second request received from a second client device.

The method can include maintaining respective metadata for each of the plurality of non-fungible tokens in a storage system.

The method can include determining that each non-fungible token of the subset satisfies the respective criteria of the respective slot of the plurality of slots based on the respective metadata for the non-fungible token. The method can include the respective metadata including at least one of a rarity value, an edition number, a sport identifier, a team identifier, an athlete identifier, or a time period identifier.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated into and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular forms of ‘a,’ ‘an,’ and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 illustrates a block diagram of an example data processing system for synchronizing NFT ledgers, in accordance with one or more implementations;

FIGS. 2A-2E illustrate example user interfaces of a system for synchronizing NFT ledgers, in accordance with one or more implementations;

FIG. 3 illustrates a flow diagram of an example method for synchronizing NFT ledgers, in accordance with one or more implementations; and

FIG. 4 illustrates a block diagram of a server system and a client computer system in accordance with an illustrative implementation.

### DETAILED DESCRIPTION

The systems and methods described herein improve upon conventional blockchain systems that execute requested NFT operations by maintaining synchronized ledgers mapping NFTs on the blockchain to their associated metadata. The techniques described herein reduce overall computation strain on the blockchain network and reduce gas costs to perform NFT operations. In conventional NFT systems, metadata associated with the NFT is stored with the NFT and may be updated infrequently due to excessive time and resource consumption involved with accessing the blockchain network. Furthermore, by integrating NFTs into various processing systems, more frequent updating of the metadata becomes ubiquitous, thereby necessitating faster and less wasteful updates to the NFT system to ensure uninterrupted gameplay. For contests based on live events, balancing consistent and accurate maintenance of the metadata associated with the NFT while reducing the computational costs and latency associated with maintaining the NFT proves to be a great technical challenge. This technical challenge can cause decreased blockchain network performance and introduces latencies in updating the NFTs.

The techniques described herein solve these and other issues by implementing synchronized ledgers that maintain associations between the NFT stored on the blockchain and the metadata associated with the NFT stored in a storage system separate from the blockchain. In this manner, updates to the NFTs can be reflected and listed in the storage system, by which the contests can access current metadata associated with the NFT, such as ownership, type, rarity, or other such attributes without necessitating accessing the NFT on the blockchain network. The systems and methods depicted herein can access the storage system to provide a list of identifiers of NFTs for performance of various operations to the blockchain network to reduce computational resources. For example, the systems and methods described herein can aggregate the list of identifiers of NFTs to provide a bulk transfer/operation with the blockchain network to reduce latency, gas costs, or computational power. The techniques described herein therefore provide technical improvements to blockchain processing systems that implement NFT-based contests.

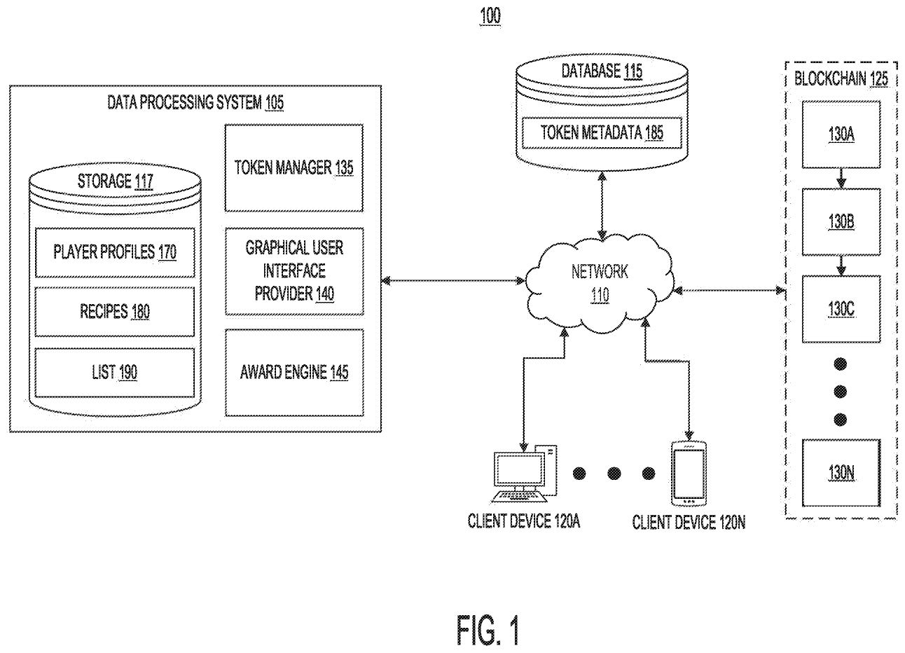

Referring now to FIG. 1, a system 100 is shown that includes a data processing system 105, a database 115, one or more client devices 120A-120N (sometimes generally referred to in the singular or the plural as “client device(s) 120”) and a blockchain network 125. The data processing system 105 can maintain a storage system including metadata of NFTs synchronized with NFTs stored on the blockchain network 125. The data processing system 105 can be a server system, a cloud-computing platform, a local computing system, a node in a distributed network, a desktop computer, a client device, or any other system that can process information. The data processing system 105 can be or include one or multiple computing nodes, servers, or distributed processing systems. The data processing system 105 can include a token manager 135, a graphical user interface provider 140, an award engine 145, an operations coordinator 150, and storage 117. The token manager 135, the graphical user interface provider 140, the award engine 145, the operations coordinator 150, and the storage 117 can include software, applications, scripts, code, objects, hardware, or the like (or combinations thereof) that are configured to perform the various tasks, operations, and techniques described herein.

The token manager 135, the graphical user interface provider 140, the award engine 145, the operations coordinator 150, and the storage 117 can be implemented on a single data processing system 105 or implemented on multiple, separate data processing systems 105. The token manager 135, the graphical user interface provider 140, the award engine 145, the operations coordinator 150, and the storage 117 can include portions of computer software, modules, software components, combinations of hardware and software components, or the like. Although various processes are described herein as being performed by the data processing system 105, it should be understood that said operations or techniques may also be performed by other computing devices (e.g., one or more client devices 120, nodes of the blockchain network 125, etc.), either individually or via communications with the data processing system 105. Similarly, the client device 120 may include one or more of the components (e.g., the token manager 135, the graphical user interface provider 140, the award engine 145, the operations coordinator 150, and the storage 117) of the data processing system 105 and may carry out any of the various functionalities described herein.

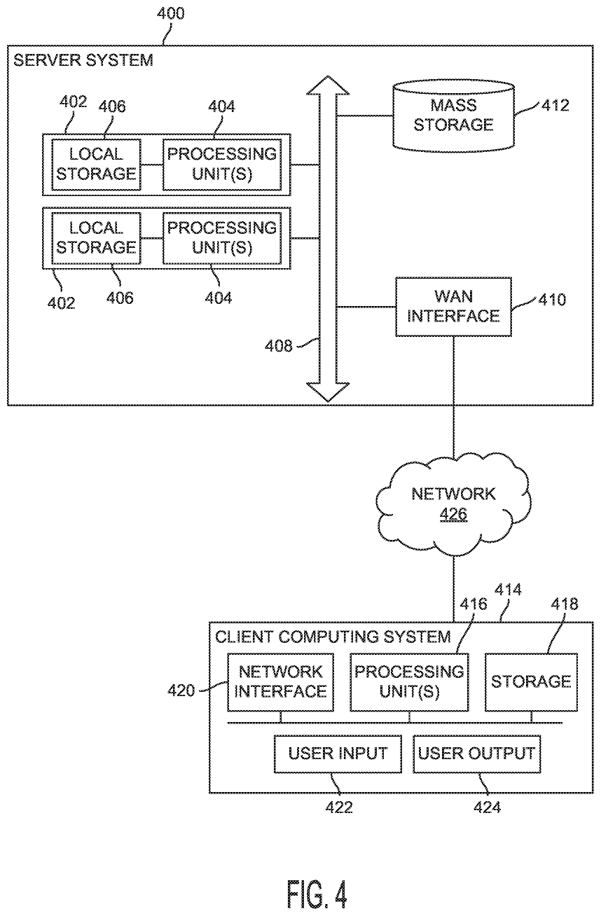

The data processing system 105 can include at least one processor and a memory (e.g., a processing circuit). The memory can store processor-executable instructions that, when executed by a processor, cause the processor to perform one or more of the operations described herein. The processor may include a microprocessor, an application-specific integrated circuit (ASIC), a field-programmable gate array (FPGA), a graphics processing unit (GPU), a tensor processing unit (TPU), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The data processing system 105 can include one or more computing devices or servers that can perform various functions as described herein. The data processing system 105 can include any or all the components and perform any or all the functions of the computer system 400 described in connection with FIG. 4.

The network 110 can include computer networks such as the Internet, local, wide, metro or other area networks, intranets, satellite networks, other computer networks, such as mobile phone (voice or data) communication networks, or combinations thereof. The data processing system 105 of the system 100 can communicate via the network 110 with one or more computing devices, such as the one or more client devices 120. The network 110 may be any form of computer network that can relay information between the data processing system 105, the one or more client devices 120, the database 115, the blockchain network 125, and one or more information sources, such as web servers or external databases, amongst others. In some implementations, the network 110 may include the Internet and/or other types of data networks, such as a local area network (LAN), a wide area network (WAN), a cellular network, a satellite network, or other types of data networks. The network 110 may also include any number of computing devices (e.g., computers, servers, routers, network switches, etc.) that are configured to receive or transmit data within the network 110.

The network 110 may further include any number of hardwired or wireless connections. Any or all of the computing devices described herein (e.g., the data processing system 105, the one or more client devices 120, the computer system 100, etc.) may communicate wirelessly (e.g., via Wi-Fi, cellular communication, radio, etc.) with a transceiver that is hardwired (e.g., via a fiber optic cable, a CAT5 cable, etc.) to other computing devices in the network 110. Any or all of the computing devices described herein (e.g., the data processing system 105, the one or more client devices 120, the computer system 100, etc.) may also communicate wirelessly with the computing devices of the network 110 via a proxy device (e.g., a router, network switch, or gateway).

The database 115 can be or include a data repository, a database, a set of databases a storage medium, or non-transitory memory device(s), among others. The database 115 is shown, in this example, as being external to the data processing system 105. However, in some implementations, the database 115 may be internal to the data processing system 105. The database 115 may be associated with a database URI, which may identify a location of a file, script, or network-addressable location of the database 115 that enables access to the token metadata 185. For example, the database URI may be a network address for the database 115, or a directory, filesystem, or memory structure stored within the database 115, which may be utilized to access the functionality of the database 115. The contents of the database 115 may be accessed using one or more application programming interfaces (APIs) (e.g., a REST API) or through software using the URI. In an example, the database URI may point, for example, to a cloud storage bucket, a key, a portion of a key, or combinations thereof, to access, retrieve, modify, delete, or create any of the information described herein, including token metadata 185.

Token metadata 185 for a token (e.g., an NFT associated with a contest, etc.) can be stored in association with, and may be accessed based on, a corresponding token identifier that uniquely identifies the token. The token metadata 185 for a particular token may be created, deleted, retrieved, modified, or otherwise accessed using a corresponding URI that accesses the token metadata 185 within the database 115. The database 115 can store corresponding token metadata 185 for any number of tokens and token types, including NFTs (e.g., ERC-721 tokens). The token metadata 185 may include any information relating to the token to which it corresponds. The token metadata 185 may be stored, for example, in the JavaScript Object Notation (JSON) format. The token metadata 185 for a token may include, but is not limited to, a token name, a token description, an image, thumbnail, graphic, audio, video, or other content (e.g., media files), creator information, date of creation, edition information (e.g., an edition number, collection identifier, pack identifier, promotion identifier, etc.), rarity information (e.g., a rarity value corresponding to a “common”, “elite” or “legendary”, etc.), or other attributes, such as a “superstar” attribute. In some implementations, the token metadata 185 for a token may include an identifier of an athlete, identifiers of one or more fantasy sports contests in which the token has been an entrant, outcomes of any past fantasy sports contests in which the token was entered, an identifier of a team corresponding to the token (e.g., a sports team for the athlete identified in the token, etc.), or any other information relating to fantasy sports.

In some implementations, the token metadata 185 may include identifying information, such as an address within the blockchain 125 corresponding to the token. The address can be represented in various formats, including, but not limited to, hexadecimal, alphanumeric strings, QR codes, or other encoded forms. In some implementations, the token metadata 185 may include an identifier of a player profile 170 associated with the token. The identifier can be a username, a player ID, or another identifier specific to the game. Additionally, in some implementations, the token metadata 185 may identify the corresponding player profile 170 as the owner of the NFT.

Although shown here as external to the data processing system 105, the database 115 may, in some implementations, be internal to the data processing system 105. In some implementations, the database 115 may, for example, be part of a cloud computing system or an external computing device in communication with the devices (e.g., the data processing system 105, the client devices 120, etc.) of the system 100 via the network 110. The database 115 may store any other information described herein, including token identifiers, metadata URIs, database URI(s), or any other information described herein. In some implementations, the database 115 may implement authentication procedures (e.g., key sharing, encryption, etc.) such that only the data processing system 105 can modify the token metadata 185 of a token. In some implementations, the client devices 120 may have read access, but cannot modify, the contents of the database 115. In some implementations, the database 115 may not authorize access to the client devices 120. In such implementations, the client devices 120 may transmit a request to access the token metadata 185 to the data processing system 105, which can retrieve and provide the token metadata 185 to the requesting client device 120. In some implementations, the client devices 120 may request to modify the token metadata 185, such as modifying an address of the token metadata 185 or other attributes associated with the NFT. For example, upon receiving such a request, the data processing system 105 may modify the token metadata 185 accordingly. In some implementations, the data processing system 105 may implement corresponding changes to the token itself stored in the blockchain 125, such as updating the address of the NFT to match the modified address in the token metadata 185. Token metadata 185 may be generated by the data processing system 105, for example, when a token is minted on the blockchain. The token metadata 185 for a token can include the identifier of the minted token, which may be retrieved from the blockchain network 125.

Each of the client devices 120 can include at least one processor and a memory (e.g., a processing circuit). The memory can store processor-executable instructions that, when executed by the processor, cause the processor to perform one or more of the operations described herein. The processor can include a microprocessor, an ASIC, an FPGA, a GPU, a TPU, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language. The client devices 120 can include one or more computing devices or servers that can perform various operations as described herein. The one or more client devices 120 can include any or all of the components and perform any or all of the functions of the client computing system 414 described herein in conjunction with FIG. 4.

Each client device 120 can be a personal computer, a laptop computer, a television device, a smart phone device, a mobile device, or another type of computing device. Each client device 120 can be implemented using hardware or a combination of software and hardware. Each client device 120 can include a display or display portion. The display can include a display portion of a television, a display portion of a computing device, or another type of interactive display (e.g., a touchscreen, etc.). Each client device 120 may include one or more I/O devices (e.g., a mouse, a keyboard, digital keypad, buttons, trackpads, touch sensor of the touchscreen, etc.). The display can include a touch screen displaying an application, such as a web browser application or a native application, which may be used to access the functionality of the data processing system 105, as described herein.

A client device 120 can receive interactions from a player. The client device 120 may also receive interactions via any other type of I/O device. The interactions can result in interaction data, which can be stored and transmitted by the processing circuitry of the client device 120. The interaction data can include, for example, interaction coordinates, an interaction type (e.g., drag, click, swipe, scroll, tap, etc.), and an indication of an actionable object (e.g., an interactive user-interface element, such as a button, hyperlink, etc.) with which the interaction occurred. The interaction data can identify a user-interface element with which the interaction occurred.

Each client device 120 can include an input device that couples or communicates with the display of each client device 120 to enable a player to interact with or select one or more actionable objects as described herein. The display can enable interaction with one or more visual indications provided through the display of each client device 120, and be responsive to an interaction (e.g., select, click-on, touch, hover). The client device 120 can generate an indication identifying a user input or selection of a wager, a live event, a contest, an NFT, or submittal of a lineup, among others.

Each of the client devices 120 can include or be identified by a device identifier, which can be specific to each respective client device 120. The device identifier can include a script, code, label, or marker that identifies a particular client device 120. In some implementations, the device identifier can include a string or plurality of numbers, letters, characters, or any combination of numbers, letters, and characters. In some embodiments, each client device 120 can have a unique device identifier. Each client device 120 can include a client application, which can be a web browser or a native application that communicates with the data processing system 105 to present user interfaces, enter NFTs into contests, request retrieval of token metadata 185, generate one or more data records corresponding to a live event (e.g., a post, a wager, etc.), or other functionality described herein. The application interfaces can, for example, be application interfaces that present different types of configuration interfaces for various tokens minted by data processing system 105, such as an interface to update a lineup of contests or a selection to retrieve or access token metadata 185 of one or more tokens minted via the data processing system, among other functionalities. The client application can be executing on each client device 120 and may be provided to the client device 120 by the data processing system 105 or via an application distribution platform. The application can include a web application, a server application, a resource, a desktop, or a file.

The application can include a local application (e.g., local to a client device 120), hosted application, a SaaS application, a virtual application, a mobile application, or other forms of content. In some implementations, the application can include or correspond to applications provided by remote servers or third-party servers. In some implementations, the application can access player profiles 170, recipes 180, lists 190 stored and maintained in the storage 117, or token metadata 185 stored and maintained in the database 115. The application may generate or otherwise present one or more interactive user-interface elements, include user-selectable hyperlinks, buttons, graphics, videos, images, or other interactive elements to control the functionality of the application make corresponding requests to the data processing system 105 to perform any of the techniques described herein. Interactions with such interactive user-interface elements (sometimes referred to as “actionable objects”) can cause the application executing on the respective client device 120 to generate a signal, which can cause the application to perform further operations corresponding to the actionable object.

In some implementations, one or more client devices 120 can establish one or more communication sessions with the data processing system 105. A communication session can include a channel or connection between the data processing system 105 and a respective client device 120. The one or more communication sessions can each include an application session (e.g., virtual application), an execution session, a desktop session, a hosted desktop session, a terminal services session, a browser session, a remote desktop session, a URL session or a remote application session. Each communication session can include encrypted or secure sessions, which can include encrypted files, data, or traffic. The session may be established based on information of a player profile 170 of a user accessing the functionality of the data processing system 105.

In some implementations, in response to interactions with corresponding user-interface elements, the application executing on a client device 120 can transmit information, such as player profile 170 information (e.g., changing player profile 170 parameters, changing login information, etc.), interaction information, selections of wager amounts, selections to input tokens into a lineup, selections to request information about the status of a contest, selections to request token metadata 185 of one or more tokens associated with the player profile 170 of the player, among other selections or requests described herein. For example, the client device 120 can transmit a request to invoke one or more proxy contracts, for example, to mint one or more tokens (e.g., NFTs) via the blockchain network 125.

In some implementations, a player, via a client device 120, can interact with user interface elements such as menus, lists, or other interactive elements described herein to identify and select one or more NFTs for burning. The process can include selecting specific NFTs from their collection or choosing NFTs as ingredients for a crafting recipe 180. In some implementations, the client application can visually highlight or confirm the selected NFTs. Once the desired NFTs are confirmed, the player can initiate the burning process by interacting with an interactive button, which when interacted with causes the client application to send a request to the data processing system 105 to enqueue the selected NFTs for processing. In some implementations, the client application can identify a recipe 180 in the request. The request can include, but is not limited to, NFT identifiers of the selected NFTs, player authentication to verify identity and ownership, and any additional information required, such as recipe identifiers for crafting, among others.

In some implementations, the client application can receive and present a confirmation prompt from the data processing system 105 before initiating the burn operation. The prompt can notify the player about the action, enabling them to review details such as a summary of the selected NFTs and the intended outcome. Upon confirmation, the client application can send the prepared burn request to the data processing system 105. The data processing system 105 can validate the request, burn the NFTs (or enqueue the NFTs for a future, batch burning process), and remove them from the player's inventory and/or database 115. After the successful completion of the burn operation, the client device 120 can receive a notification from the data processing system 105 that confirms that the selected NFTs were successfully burned and include details about any rewards received for burning the NFTs, such as new NFTs, in-game currency, or access to exclusive features.

The blockchain network 125 includes a decentralized system of nodes, e.g., computing systems, each maintaining a copy of the entire blockchain. Nodes of the blockchain network 125 utilize cryptography to enable secure, transparent transfers that are verifiable on blocks 130A-130N (sometimes generally referred to herein as “block(s) 130”) on the blockchain. Each node in the blockchain network 125 can validate new transfers, following a consensus protocol of the blockchain network 125. When a new block 130 is created, the new block 130 can include a list of recent, validated transfers. As shown, each block 130 (including a newly created block 130) is linked to the previous block 130 of the blockchain. The link may be generated via a cryptographic hash, creating a “chain” of blocks.

The blocks 130 of the blockchain network 125 can each include a list of transfers/operations that have been validated by the nodes of the blockchain network 125, a reference to the previous block in the chain, state data of the blockchain, uncle blocks (or ommer), as well as encoded bytecode for one or more smart contracts. Blockchain networks 125 are secure because, to tamper with a transfer, an attacker would need to modify the block containing the transfer/operation, as well as all subsequent blocks. Due to the distributed nature of the blockchain network 125, doing so would exceed the combined computational power of the entire network, thereby making the blockchain secure against such attacks. Smart contracts, which are self-executing contracts with the terms of the agreement that are directly written into code, can also be hosted on the blockchain, enabling decentralized applications that may be capable of minting tokens.

Smart contracts include digital programs that execute predefined rules or conditions when deployed onto the blockchain network 125 (e.g., in a corresponding block 130). Smart contracts include self-executing contracts with terms of the agreement being directly written into code. These terms can include everything from simple transfers (like sending a certain amount of cryptocurrency from one wallet to another) to complex logic. Smart contracts are compiled into bytecode and then deployed onto the blockchain by creating a transfer that includes the bytecode of the smart contract, which is then broadcast to the blockchain network 125. Once the transfer is confirmed, the smart contract becomes a part of the blockchain, assigned with a unique address in a block 130. Smart contracts described herein can be executed to perform various functionality, including minting tokens (e.g., NFTs such as ERC-721 tokens, etc.). Smart contracts may also cause the blockchain network 125 to execute (e.g., invoke) other smart contracts on the network, using a corresponding address of the smart contract that is to be executed, along with any parameters or arguments that are to be passed to said smart contract. Smart contracts may be able to store certain information, including lists of addresses to other contracts.

The storage 117 can be a computer-readable memory that can store or maintain any of the information described herein. The storage 117 can store or maintain one or more data structures, which may contain, index, or otherwise store each of the values, pluralities, sets, variables, vectors, numbers, or thresholds described herein. The storage 117 can be accessed using one or more memory addresses, index values, or identifiers of any item, structure, or region maintained in the storage 117. The storage 117 can be accessed by the components of the data processing system 105, or any other computing device described herein, via the network 110. In some implementations, the storage 117 can be internal to the data processing system 105. In some implementations, the storage 117 can exist external to the data processing system 105 and may be accessible via the network 110. The storage 117 can be distributed across many different computer systems or storage elements and may be accessed via the network 110 or a suitable computer bus interface. The data processing system 105 can store, in one or more regions of the memory of the data processing system 105 or in the storage 117, the results of any or all computations, determinations, selections, identifications, generations, constructions, or calculations in one or more data structures indexed or identified with appropriate values.

Any or all values stored in the storage 117 may be accessed by any computing device described herein, such as the data processing system 105, to perform any of the functionalities or functions described herein. In some implementations, a computing device, such as a client device 120, may utilize authentication information (e.g., username, password, email, etc.) to show that the client device 120 is authorized to access requested information in the storage 117. The storage 117 may include permission settings that indicate which users, devices, or profiles are authorized to access certain information stored in the storage 117. In some implementations, instead of being internal to the data processing system 105, the storage 117 can form a part of a cloud computing system. In such implementations, the storage 117 can be a distributed storage medium in a cloud computing system and can be accessed by any of the components of the data processing system 105, by the one or more client devices 120 (e.g., via one or more user interfaces, etc.), or any other computing devices described herein.

The storage 117 can store or otherwise maintain one or more player profiles 170, for example, in one or more data structures. Each player profile 170 can be associated with a corresponding player (e.g., a user) of a client device 120 that accesses the functionality of the data processing system 105. In implementations where the data processing system 105 can operate without using a client device 120 (e.g., a slot machine, a video game machine, a standalone kiosk, etc.), a player profile 170 may correspond to a player that accesses the data processing system 105 to place wagers, enter contests, or access token metadata 185 of one or more tokens associated with the player profile.

The data processing system 105 may correspond to a central wallet address, which is recorded on the blockchain as storing, or “owning” various tokens minted. In some implementations, each player profile 170 may include a list of tokens that are maintained by the central wallet and owned by the corresponding player of the player profile 170. In some implementations, the data processing system 105 can maintain a table or other data structure associating a token with a respective player profile 170 that owns said token, if any. The table or data structure may include an indication that a token is not owned. The data processing system 105 can update the list of tokens as the player acquires, sells, burns/discards, or trades tokens. A client device 120 may, in some implementations, transmit requests to access the list of tokens of the player profile 170 of the player using the client device 120. In response, the data processing system 105 can access the player profile 170 to identify the tokens owned by the player. In some implementations, the data processing system 105 can access the token metadata 185 corresponding to the tokens identified in the player profile 170, to perform updates (e.g., in response to changes in contest status or to user requests for discarding specific tokens). The data processing system 105 can provide the token metadata 185 in the form of content to the client device 120 for display, including the execution of discard actions.

Each player profile 170 can be a user profile that includes information about a user (sometimes referred to as a “player”). Each player profile 170 may include information about one or more of the client devices 120 used to access the data processing system 105 using the player profile 170. For example, identifiers of a player profile 170 can be used to access the functionality of the data processing system 105 via the network 110. In some implementations, a player profile 170 may include a private key. The private key can be used to access or associate one or more tokens with the player profile 170, in some implementations. A private key may indicate to or confirm for the data processing system 105 that a player owns one or more token(s).

The identifiers of player profiles 170 can include a username, a password, an e-mail address, a phone number, a personal identification number (PIN), a secret code-word, a private key or device identifiers for use in a two-factor authentication technique, among others. The player profile 170 can store historical information about contests, such as contests viewed, selected, wagered upon (including, e.g., parlay wagers), or entered using the tokens identified in the player profile 170, or live event outcomes, or other historical information. The player profile 170 can store credit balance or wager information (e.g., an amount of a wager, a timestamp associated with a wager, information about the presence of an indication to participate in a bonus opportunity using the wager, a client device identifier of a client device 120 that was used to submit a lineup, tokens, or other information or entry data to a contest, the number of contests played using the player profile 170, etc.). The player profile 170 can store indicators of the outcomes of contests that the corresponding player has entered.

The player profile 170 can store information about a client device 120 used to access the data processing system 105, such as an internet protocol (IP) address, a media access control (MAC) address, a global unique identification (GUID), a player profile 170 name (e.g., the name of the user of the client device 120, a player-chosen username, etc.), or a device name, among others. In some implementations, a player profile 170 can be created by the data processing system 105 in response to a player profile 170 creation request transmitted by a client device 120. The player profile 170 creation request can include any of the player profile 170 information described herein. In some implementations, a client device 120 accessing the data processing system 105 may not be associated with a player profile 170. In such implementations, the data processing system 105 can automatically create a player profile 170 using an identifier of the client device 120 provided by the client device 120.

The storage 117 can store recipes 180, each identified by a recipe identifier. The recipes 180 represent the instructions and requirements for crafting various in-game items or acquiring reward(s). Each recipe 180 can correspond to a set of inputs that are to be completed to craft the recipe 180 and generate or otherwise associate the player profile 170 with a corresponding reward. Each input within a recipe 180 can be filled with (or associated with) a specific NFT that satisfies corresponding criteria of the inputs, and one or more tokens may be required to satisfy criteria determined by the recipe 180. The criteria for crafting a recipe 180 may include various attributes, including the rarity of the token, an edition number of the token, a team identifier associated with the token, a player name associated with the token, a position associated with the token, a provenance of the token, or any other attributes defined in the token metadata 185, among others. When a player provides a request to craft a recipe 180, the data processing system 105 retrieves the corresponding recipe data, including the defined inputs and associated criteria.

The data processing system 105 can then present a graphical user interface to the player that indicates the criteria for each input of the recipe 180. The graphical user interface may include interactive elements that enable the player to select from one or more NFTs associated with their corresponding player profile 170. The interactive elements may enable filtering and/or sorting of presented content items that represent the NFTs, to enable selection of the NFTs to satisfy the requirements of the recipe 180. Upon receiving selections of NFTs to process in connection with the recipe 180, the data processing system 105 validates the tokens provided by the player against the criteria of the recipe 180. Upon each selected token successfully satisfying the criteria of the the inputs of recipe 180, the recipe 180 is deemed crafted. The successful completion of recipe 180 can initiate a subsequent process, such as the enqueueing, burning, or otherwise discarding of the involved tokens from active circulation and awarding the player with a predetermined reward associated with the recipe 180. In some implementations, the recipe 180 may award a newly minted token or an upgraded token.

The storage system 117 can maintain a list 190, which can be a structured database table or a similar data structure for tracking and maintaining tokens. The list 190 can be updated to record and update the status of tokens associated with a player profile 170, particularly the tokens marked for discarding or burning. In some implementations, the list 190 can function as a queue for processing tokens marked for discarding or burning, particularly those involved in crafting recipes 180. The list 190 can enable tracking of the selected tokens. In some implementations, a subset of the list 190 may be displayed within the graphical user interface to enable players to browse their collection and select NFTs for burning. In some implementations, the section of the list 190 can provide filtering capabilities based on various criteria, such as identifiers (e.g., IDs for each NFT), attributes (properties of the NFTs), and status (whether an NFT is ready to be burned or used in crafting). It is to be noted that the complexity of filtering capabilities/options can be adjusted. For example, if the primary purpose is to discard NFTs, a simple list of addresses/identifiers may be enough. Additional filtering options may be utilized to filter the list 190, in some implementations.

In some implementations, the list 190 can facilitate efficient data retrieval by retrieving token metadata 185 associated with NFTs. The metadata may include details such as names, descriptions, and associated statuses, indicating whether the NFTs are available for use, engaged in a recipe, or have already been discarded. In some implementations, the list 190 can maintain a record of the respective identifiers of tokens selected in recipe 180 for discarding. The list 190 can store the identifiers of the respective tokens selected for discarding in a dedicated discard data structure.

In some implementations, the list 190 can be expanded to store and maintain a record of recipe IDs, facilitating the tracking of recipe progress, token utilization, and overall system resource management. The list 190 can use a structured data format to store recipe information, with each recipe 180 having a distinct entry that includes its identifier. Additionally, list 190 can facilitate the monitoring of the progress of each recipe 180 by tracking the fulfillment of individual NFT requirements.

Referring now to the operations of the data processing system 105, the token manager 135 can manage various aspects of tokens (e.g., NFTs), including updating, discarding, and managing the lifecycle from minting to the burning of tokens from circulation. The token manager 135 can maintain instructions or rules that define the criteria for crafting a recipe 180. Upon receiving a request from a client device 120, the token manager 135 analyzes the metadata 185 of each token to determine its compliance with the specified criteria for the recipe 180. The metadata may include a rarity value, an edition number, a sport identifier, a team identifier, an athlete identifier, or a time period identifier. Following this analysis, the token manager 135 can identify one or more tokens that satisfy the criteria for a recipe 180. When the user selects tokens via the graphical user interface described herein for crafting the recipe 180, thereby burning the tokens, the token manager 135 can store the identifiers of the selected tokens in the list 190. In some implementations, the token manager 135 can update token metadata 185 in the database 115 to reflect changes such as status updates, burning, or discarding of tokens, and manage interactions between tokens and other components of the data processing system 105.

The token manager 135 can further streamline token management by facilitating transfers on the blockchain 125, specifically for tokens that are marked for discard according to the criteria defined for crafting recipes 180. When executing the token discard operations/transfers, the token manager 135 can transfer the selected tokens to a predetermined burn address, effectively removing them from circulation. The burn address can be a designated destination for tokens that are no longer in use to be permanently removed from the system. The token manager 135 can communicate with the blockchain 125 via a secure interface. The token manager 135 can construct a transfer message specifying the burn address as the recipient and identifiers of the tokens to be discarded. The transfer message can then be submitted to blockchain 125 for validation and execution. The token manager 135 can execute the transfers in batches at predetermined time periods or upon reaching a certain threshold number of NFTs.

In some implementations, the token manager 135 can update the internal records associated with token burning before or while executing the transfers on the blockchain 125, as described herein. This may include removing the tokens from the list 190 maintained in the storage 117 and/or updating the corresponding entries in the database 115. Additionally, the token manager 135 can update the player profiles 170 associated with discarded NFTs. For example, when tokens are burned or discarded as part of crafting a recipe 180, the token manager 135 can update the respective player profiles 170 to reflect the loss of these tokens and any associated changes in their token inventory. Furthermore, in response to successfully crafting a recipe 180, the token manager 135 can add new associations with additional NFTs awarded to the players.

As described herein, the token manager 135 can retrieve identifiers of one or more tokens for crafting recipes 180 that satisfy the criteria of one or more inputs (or slots) of said recipes 180, with the capability to handle a variety of token types and formats in accordance with the criteria of the recipe 180. The token manager 135 can support any type of suitable token, including, but not limited to, ERC-721 tokens, ERC-20 tokens, ERC-1150 standard data, ERC-998 tokens, ERC-1046 tokens, or ERC-994 tokens, among others. The token manager can use a standardized data structure to represent tokens, with specific fields tailored to each token type.

Additionally, the token manager 135 can update specific token-related data. The token manager 135 can maintain and update token metadata 185 in the database 115 or the list 190 in storage 117, which can track the statuses of tokens, such as their availability, engagement in recipes, or discard status. The token manager 135 can use a series of well-defined functions to add, remove, or modify tokens (e.g., alter the token's identifiers or addresses) in the list 190 to keep the list 190 up-to-date. The token manager 135 can manage transfers, which include updates to token metadata 185 in the database 185 and changes in token status. For example, as described herein, the token manager 135 can identify tokens by their identifiers to apply the necessary updates, and these updates are reflected in the token metadata 185.

The graphical user interface provider 140 can provide an interactive visual representation of the system's environment and features to the client devices 120 associated with respective player profiles 170. The graphical user interface provider 140 can act as a bridge between the system's state and the player's interaction, enabling navigation, interaction with elements, and feedback reception on actions performed. For example, the graphical user interface provider 140 can receive updates that represent the current state of the environment, including positions, interactions, and changes. The updates are then transformed into graphical elements such as icons, animations, and text, and are rendered on the display of the client device 120.

Additionally, the graphical user interface provider 140 can manage player inputs such as keystrokes, clicks, and touch gestures. The graphical user interface provider 140 can process the inputs and translate them into corresponding system actions such as selections and menu navigation. For example, when a user selects a recipe 180 for crafting, the graphical user interface provider 140 can present an interface with various interactive elements that enable the user to perform the crafting activity. The actions initiated by the user are communicated to the data processing system 105, influencing its state and prompting updates that the graphical user interface provider 140 renders. The graphical user interface provider 140 can also provide auditory elements. For example, sound effects and music can be integrated and synchronized with visual events, such as confirming a selection or completing a crafting step.

The award engine 145 can generate and/or provide awards or execution various operations as a result of satisfying criteria for one or more recipes 180. The award engine 145 can process or set forth various criteria and conditions to determine the eligibility for and type of awards to be associated with corresponding player profiles 170. The award engine 145 can monitor player activities, achievements, and interactions and use this data to determine and assign rewards accordingly. The award engine 145 can interface with other components of the data processing system 105, such as the token manager 135 and the graphical user interface provider 140. Upon determining that the criteria for a recipe 180 have been satisfied, the award engine 145 can initiate the provision of a virtual reward, which may include virtual items, tokens, points, or other valuable game assets. The award engine 145 can update the player profile 170 with newly earned rewards and provide a notification to inform the player about their accomplishments or acquired rewards. In some implementations, the notification can be delivered to the client device 120 associated with the player profile 170 through various communication protocols, including integrated interface alerts, push notifications, and email, among others.

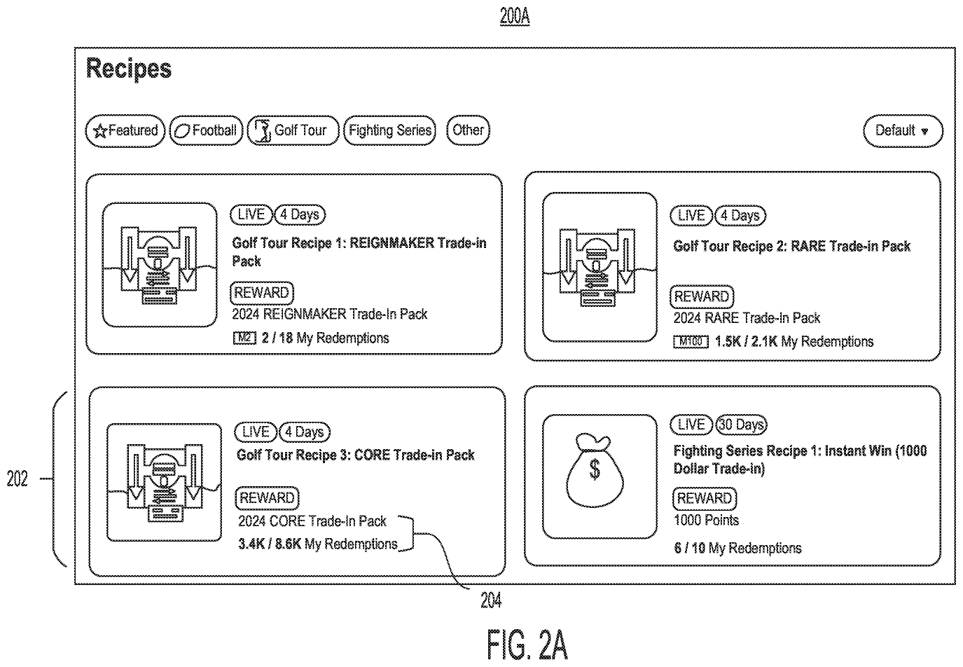

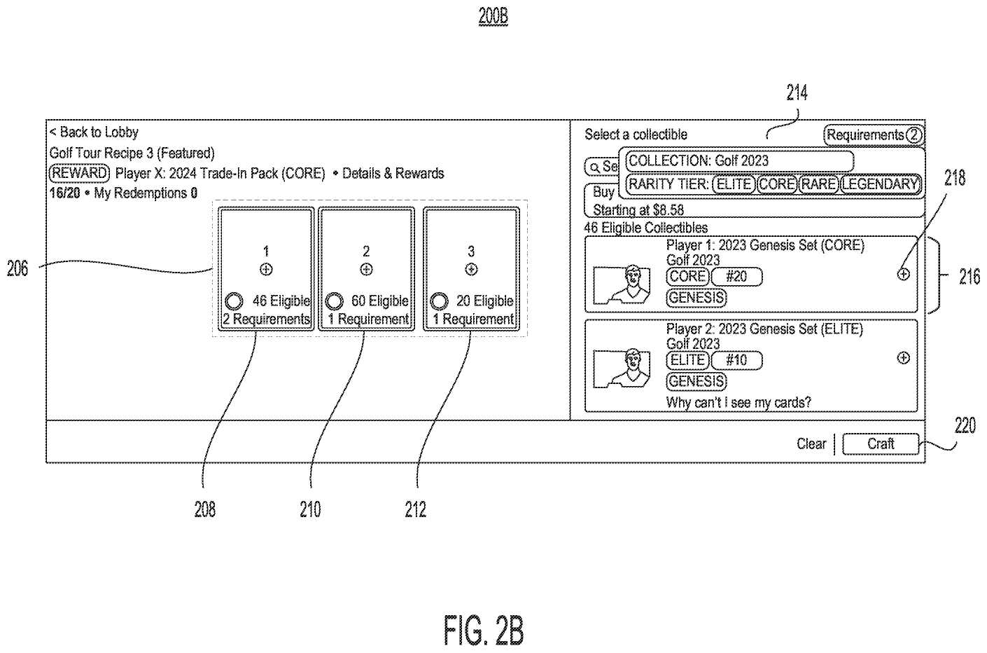

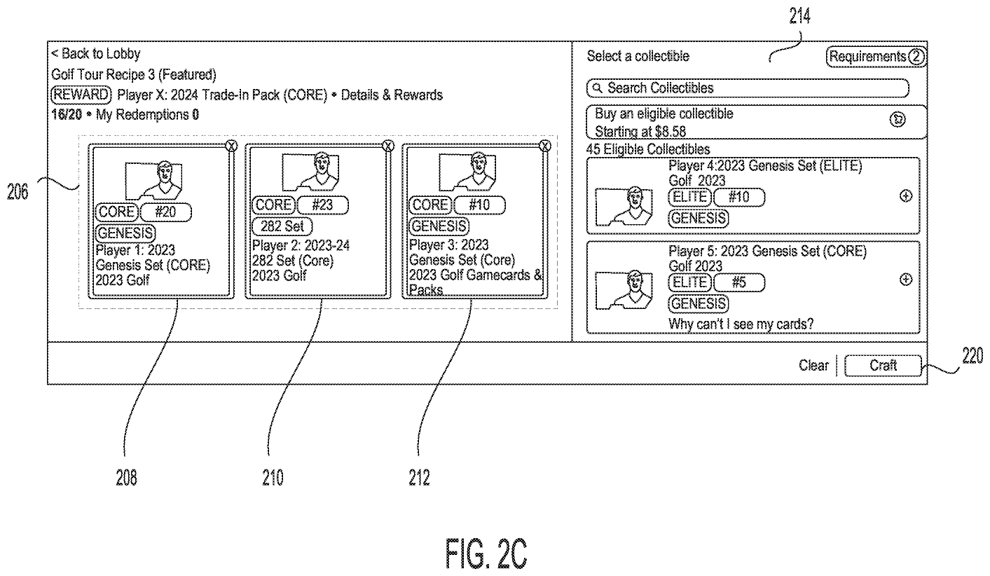

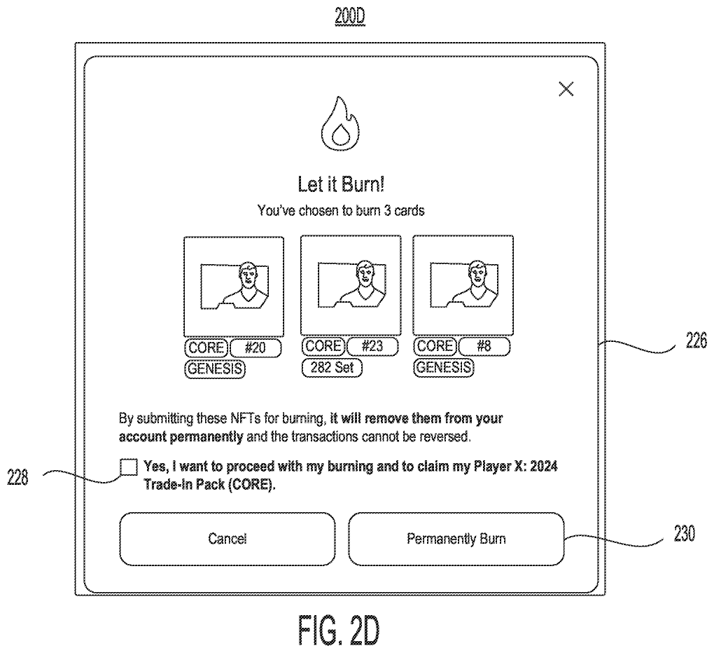

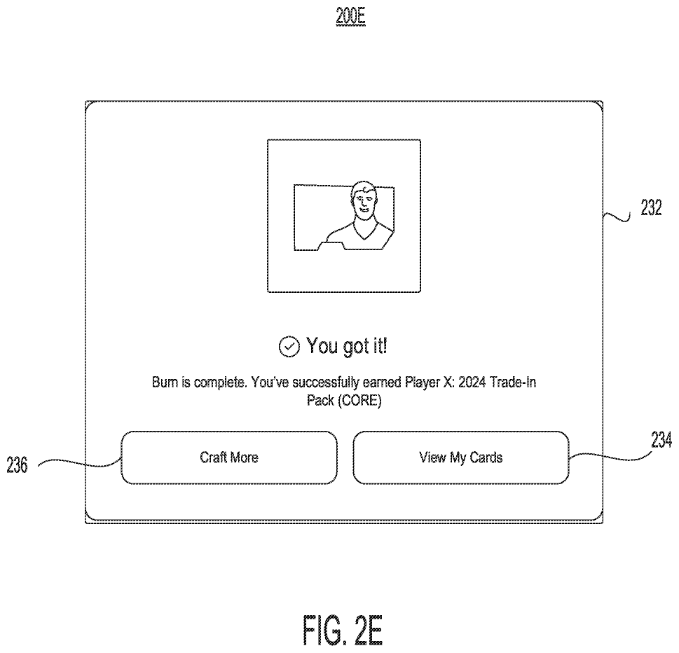

In some implementations, the award engine 145 can facilitate redemption processes, which may involve “burning” selected tokens (e.g., expired tokens), as described herein. To facilitate this exchange, a user can select tokens to satisfy criteria for a recipe 180, as described herein. Various further operations relating to these techniques are described in connection with the graphical user interfaces shown in FIGS. 2A-2E.

Referring now to FIGS. 2A-2E in the context of the components described in connection with FIG. 1, illustrated are example user interfaces 200A-200E that can be displayed by an application executing on a client device (e.g., the client device 120). The application can be associated with, and communicate with, the data processing system 105 via one or more networks (e.g., the network 110). The application can include actionable objects. Some example actionable objects that enable the player to make selections can include drop-down menus, interactive buttons, hyperlinks, search bars, or other types of graphical user interface elements.

Referring now to FIG. 2A in the context of the components of FIG. 1, illustrated is an example user interface 200A, showing a plurality of available recipes 180 that are available on the platform. In some implementations, one or more of the recipes 180 can be associated with a player profile 170. Below a set of interactive user interface elements (e.g., “Featured”) is a list of available recipes 180 (e.g., which may include a curated selection of recipes that are highlighted or prioritized for a user). The available recipes 180 can be selected via interactions with the application presenting the user interface 200A. Each recipe 180 (indicated in the user interface 200A as a respective recipe content item 202) can include an identifier, such as a name, that distinguishes it from other recipes. In some implementations, additional identifiers can be associated with specific attributes of the recipe content item 202, which can provide valuable context. For example, each recipe content item 202 can be tagged with relevant categories (e.g., NFL, NBA, UFC, etc.) to indicate the types of sporting events, competitions, or category for which the rewards associated with the recipe 180 can be applied.

In some implementations, each recipe content item 202 can include a reward identifier. The reward identifier can indicate the specific reward that a player can acquire upon successfully crafting the corresponding recipe. The reward identifier may correspond to an athlete identifier and a year identifier. The athlete identifier specifies the athlete's name associated with the reward, which can provide a player with an understanding of the award's significance and potential value. The year identifier may be used to identify a specific year associated with the recipe content item 202. For example, in some implementations where the year identifier identifies the year “2024,” the recipe 180 can be associated with that particular year. In some implementations, the year identifier may indicate that the recipe content item 202 can be redeemed using an NFT from that corresponding year. For example, the year identifier corresponding to the year “2023” may indicate that a token minted or earned in 2023 would be required for redemption.

Each recipe content item 202 can include a dynamic live status indicator that shows whether the reward associated with the recipe content item 202 is currently available for redemption. In some implementations, the live status indicator can display when crafting becomes available for the recipe content item 202, or the time limit for redeeming its associated reward. For example, the data processing system 105 can present a countdown of the remaining time for each recipe content item 202 on the user interface 200A.

Each recipe content item 202 can include an associated redemption region 204, which provides information about the recipe's redemption status. As shown, the redemption region 204 displays the total number of redemptions associated with a particular recipe content item, along with the number of redemptions already redeemed from this total. In some implementations, the redemption region 204 may include a fractional representation of the redemptions, where the numerator indicates the number of player profiles 170 that have redeemed the associated reward, and the denominator indicates the total number of redemptions associated with the recipe content item 202. In some implementations, the redemption region 204 can display the number of redemptions associated with a player profile 170 accessing the recipe content item 202.

In some implementations, each recipe content item 202 can include a token identifier that identifies whether the recipe 180 can be crafted using core tokens, rate tokens, elite tokens, or other predefined categories of NFTs. In some implementations, the data processing system 105 can dynamically assign NFT categories to recipes 180 during their creation based on the involved NFT types and other relevant factors. The information can then be integrated into the recipe feed, which the data processing system 105 can update. In some implementations, users can access the information through individual recipe content items 202 displayed on the user interface. In this example, the displayed recipe content item 202 indicates that core tokens are required for crafting. Each recipe content item 202 can be interactive and selected by a player through various means, such as tapping on a touch screen or clicking with a mouse. Once a player interacts with the recipe content item 202 (e.g., Golf Tour Recipe 3 in this example), the application displaying the user interface 200A transitions to an updated user interface, such as the user interface depicted in FIG. 2B.

Referring now to FIG. 2B in the context of the components of FIG. 1, illustrated is an example user interface 200B, showing a slot region 206 associated with the recipe content item 202 selected by a player in FIG. 2A. The slot region 206 can include one or more slots (e.g., inputs) for discarding or burning a single NFT or a combination of NFTs. In this example, three slots (e.g., 208, 210, and 212) are associated with the recipe content item 202, but any positive integer of slots can be implemented. Each slot can include a respective identifier corresponding to its position, whether first, second, or third. In some implementations, each slot can include a respective discarding/burning criteria. For example, the criteria for the first slot 208, as displayed, includes the number of eligible tokens (e.g., forty-six in this example) that satisfy the criteria associated with the first slot 208. In such implementations, the data processing system 105 can determine the number of eligible NFTs associated with the player profile 170 that are eligible for a respective lot. In some implementations, each slot within the slot region 206 can include predetermined requirements. For example, the first slot 208 is depicted as requiring two or any number of prerequisites (or requirements) that are to be satisfied for the respective slot to accept an NFT. The requirements, in a non-limiting example, may correspond to token metadata associated with athlete names, sports names, or any other relevant attributes.

In some implementations, adjacent to the slot region 206, the user interface 200B presents an overlay 214. The overlay 214 can display eligible tokens/NFTs determined by the data processing system 105 for the selected recipe content item 202. The overlay 214 can include one or more eligible tokens identified in the storage 117/database 115 and associated with the player profile 170. Each eligible token can be indicated as a content item that includes one or more identifiers. For example, the token content item 216 includes identifiers associated with a set name (e.g., Genesis), rarity tier (e.g., Core), edition number (#20), sport name (e.g., Golf), athlete name (indicated as “Player 1” in this example), and other relevant attributes.

In some implementations, each token content item 216 can include one or more content items. The content item 218 can be a content item to add a particular NFT to a designated slot within the slot region 206. The data processing system 105 can analyze the metadata associated with each NFT in accordance with the criteria specified for each slot. By comparing the attributes of each token to the requirements of each slot, the data processing system 105 determines compatible tokens that are to be transferred to the appropriate slots upon interaction. When a player interacts with content item 218, the data processing system 105 dynamically updates the corresponding slot to reflect the addition of the selected token.

In some implementations, a player can interact with each token by dragging and dropping it onto one of the slots within the slot region 206. In some implementations, players may interact with the corresponding token content item 216 to select the token for placement into the slot. The user interface 200B can indicate (e.g., visually in some implementations) the placement of the token within the designated slot if the data processing system 105 determines that the token satisfies the specific criteria of the slot onto which it is dropped. Additionally, feedback, such as visual, audio, or haptic feedback, can be provided to provide an immediate confirmation of whether the token is eligible for placement in that particular slot. Responsive to selecting one or more content items 216 corresponding to NFTs, each slot will be filled with a respective eligible token, as shown in connection with FIG. 2C.

Referring now to FIG. 2C in the context of the components of FIG. 1, illustrated is an example user interface 200C, showing each slot within the the slot region 206 filled/associated with a respective selected NFT. As shown, the first slot 208, the second slot 210, and the third slot 212 are filled with golf-themed NFTs (e.g., PGA-themed NFTs), corresponding to the criteria of the selected recipe content item 202. However, in some implementations, there can be mixing and matching of NFTs from different sports-themed collections according to the criteria of recipe content item 202.

Since the selected recipe content item 202 in FIG. 2A includes a rarity tier of ‘Core’, all respective slots within the slot block 206 are filled with NFTs that share the same rarity value. However, in some implementations, the respective slots may include NFTs with varying rarity values, depending on predetermined criteria or attributes associated with each NFT. As shown, the user interface 200C presents an actionable object 220, such as an option to craft the selected recipe content item 202. Interaction with the actionable object 220 can cause the application presenting the user interface 200B to transition to a confirmation user interface, such as the user interface depicted in FIG. 2D.

Referring now to FIG. 2D in the context of the components of FIG. 1, illustrated is an example user interface 200D, showing a confirmation user interface 200D to a player. As shown, the user interface 200D can include a content item 226 that displays the tokens/NFTs selected for burning. The content item 226 can provide visual confirmation of the NFTs that the player intends to utilize for the redemption process. The content item 226 can include a selectable object 228 that the player can toggle to confirm their selection. Once the player interacts with the selectable object 228, the user interface 200D can be updated to show a tick mark, indicating the player's acknowledgment of their intention to burn the selected tokens. In some implementations, the content item 226 can include an actionable object 230 that causes the data processing system 105 to initiate the burning process.

Upon interacting with the actionable object 230, the data processing system 105 removes the association of the selected tokens with the player profile 170. Additionally, the data processing system 105 can update the discard data structure for tracking discarded or burned NFTs. As described herein, the update may involve adding one or more identifiers corresponding to the burned tokens. Upon successful burning, the data processing system 105 updates the storage 117 to reflect the claimed reward of a new NFT and creates a new entry in the storage 117 for the NFT, including its unique identifier, metadata, and any other relevant information. In some implementations, the data processing system 105 can concurrently update the database 115 to reflect the same information about the new NFT and maintain records of all NFTs within the system. In response to the completion of the burning of the tokens, the application presenting the user interface 200D can transition to a completion user interface, such as the user interface depicted in FIG. 2E.

Referring now to FIG. 2E in the context of the components of FIG. 1, illustrated is an example user interface 200E, showing information related to successful recipe crafting and the redemption of associated rewards. As shown, the interface 200E includes a content item 232. The content item 232 depicts a visual representation of the reward associated with successfully crafting the selected recipe content item 202. In this example, the reward is shown as a new (or updated) NFT, providing players with visual confirmation of their achievement. The content item 232 includes one or more interactive elements 234 and 236. The interactive element 234 enables players to access an overview of all NFTs currently associated with the player profile 170. This may include the newly acquired NFT earned through recipe crafting, along with any existing NFTs in the storage 117 or database 115. By interacting with 234, players can conveniently view and manage their complete collection. The interactive element 236, upon interaction, causes the data processing system 105 to transition the user interface 200E from its current state back to the initial recipe selection interface 200A. This allows players to seamlessly return to the recipe selection process and begin crafting another recipe 180.

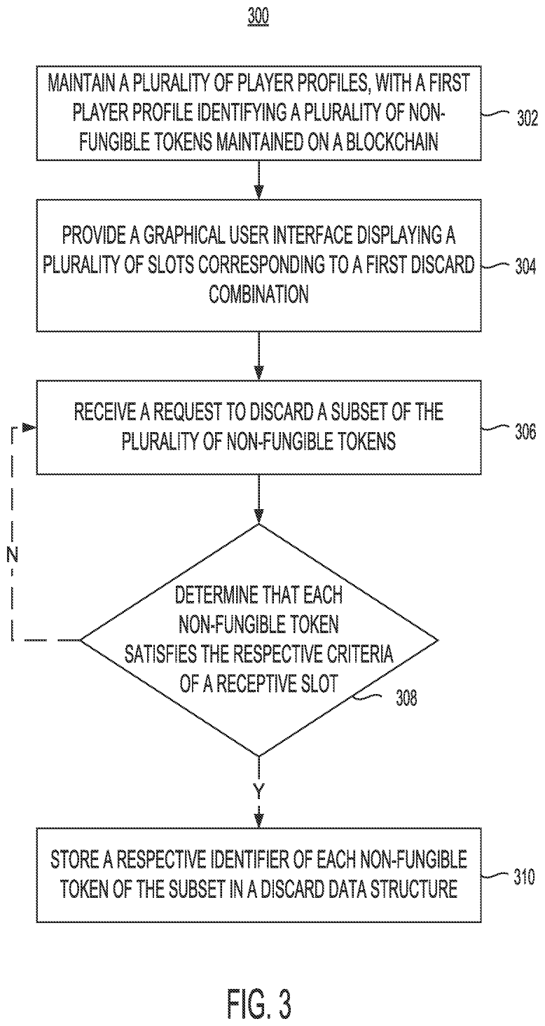

Referring now to FIG. 3, depicted is an illustrative flow diagram of a method 300 for synchronizing non-fungible token ledgers. The method 300 can be executed, performed, or otherwise carried out by the data processing system 105 or any other computing devices described herein. In brief overview of the method 300, the data processing system (e.g., the data processing system 105, etc.) can maintain a plurality of player profiles, with a first player profile identifying a plurality of non-fungible tokens maintained on a blockchain (STEP 302), provide a graphical user interface displaying a plurality of slots corresponding to a first discard combination (STEP 304), receive a request to discard a subset of the plurality of non-fungible tokens (STEP 306), determine that each non-fungible token satisfies the respective criteria of a receptive slot (STEP 308), and store a respective identifier of each non-fungible token of the subset in a discard data structure in response to determining that each non-fungible token satisfies the respective criteria of a receptive slot (STEP 310).

In further detail of the method 300, the data processing system can maintain a plurality of player profiles, with a first player profile identifying a plurality of non-fungible tokens maintained on a blockchain (STEP 302). The data processing system can store or otherwise maintain one or more player profiles, for example, in one or more data structures. In some implementations, each player profile can be associated with a corresponding player (e.g., a user) of a client device that accesses the functionality of the data processing system. In implementations where the data processing system can operate without using a client device (e.g., a slot machine, a video game machine, a standalone kiosk, etc.), a player profile may correspond to a player that accesses the data processing system to place wagers, enter contests, or access token metadata of one or more tokens associated with the player profile. In some implementations, the token metadata may include an identifier of a player profile associated with the token. The identifier can be a username, a player ID, or another identifier specific to the game. Additionally, in some implementations, the token metadata may identify the corresponding player profile as the owner of the NFT.

In some implementations, the data processing system may correspond to a central wallet address, which can be recorded on the blockchain as storing or “owning” various tokens minted. In some implementations, each player profile may include a list of tokens that are maintained by the central wallet and owned by the corresponding player of the player profile. In some implementations, the data processing system can maintain a table or other data structure associating a token with a respective player profile that owns said token, if any. The table or data structure may include an indication that a token is not owned. The data processing system can update the list of tokens as the player acquires, sells, burns/discards, or trades tokens. A client device may, in some implementations, transmit requests to access the list of tokens of the player profile of the player using the client device. In response, the data processing system can access the player profile to identify the tokens owned by the player. In some implementations, the data processing system can access the token metadata corresponding to the tokens identified in the player profile to perform updates (e.g., in response to changes in contest status or to user requests for discarding specific tokens). The data processing system can provide the token metadata in the form of content to the client device for display, including the execution of discard actions.

Each player profile can be a user profile that includes information about a user (sometimes referred to as a “player”). Each player profile may include information about one or more of the client devices used to access the data processing system using the player profile. For example, the identifiers of a player profile can be used to access the functionality of the data processing system via the network. In some implementations, a player profile may include a private key. The private key can be used to access or associate one or more tokens with the player profile, in some implementations. A private key may indicate to or confirm for the data processing system that a player owns one or more token(s).

In some implementations, the identifiers of player profiles can include a username, a password, an e-mail address, a phone number, a personal identification number (PIN), a secret code-word, a private key or device identifiers for use in a two-factor authentication technique, among others. The player profile can store historical information about contests, such as contests viewed, selected, wagered upon (including, e.g., parlay wagers), or entered using the tokens identified in the player profile, or live event outcomes, or other historical information. The player profile can store credit balance or wager information (e.g., an amount of a wager, a timestamp associated with a wager, information about the presence of an indication to participate in a bonus opportunity using the wager, a client device identifier of a client device that was used to submit a lineup, tokens, or other information or entry data to a contest, the number of contests played using the player profile, etc.). The player profile can store indicators of the outcomes of contests that the corresponding player has entered.

In some implementations, the data processing system can streamline token management by facilitating transfers on the blockchain, specifically for tokens that are marked for discard according to the criteria defined for crafting recipes. As described herein, the data processing system can retrieve identifiers of one or more tokens for crafting recipes that satisfy the criteria of one or more inputs (or slots) of said recipes, with the capability to handle a variety of token types and formats in accordance with the criteria of the recipe. Each recipe (e.g., indicated in the user interface as a respective recipe content item) can include an identifier, such as a name, that distinguishes it from other recipes.

In response to receiving an interaction with the recipe content item, the data processing system can provide a graphical user interface displaying a plurality of slots corresponding to a first discard combination (STEP 304). In some implementations, the user interface can display a slot region associated with the recipe content item selected by a player. The slot region can include one or more slots (e.g., inputs) for discarding or burning a single NFT or a combination of NFTs. For example, in some implementations, three slots (as shown in FIG. 2B) can be associated with the recipe content item, but any positive integer of slots can be implemented. Each slot can include a respective identifier corresponding to its position, whether first, second, or third.

In some implementations, each slot can include a respective discarding/burning criteria. For example, the criteria for the first slot, as displayed in FIG. 2B, includes the number of eligible tokens (e.g., forty-six in this example) that satisfy the criteria associated with the first slot. In such implementations, the data processing system can determine the number of eligible NFTs associated with the player profile that are eligible for a respective lot. In some implementations, each slot within the slot region can include predetermined requirements. For example, the first slot is depicted as requiring two or any number of prerequisites (or requirements) that are to be satisfied for the respective slot to accept an NFT. The requirements, in a non-limiting example, may correspond to token metadata associated with athlete names, sports names, or any other relevant attributes.

In some implementations, each eligible token can be indicated as a content item that includes one or more identifiers. In some implementations, a player can interact with each token by dragging and dropping it onto one of the slots within the slot region. In some implementations, players may interact with the corresponding token content item to select the token for placement into the slot. The user interface can indicate (e.g., visually in some implementations) the placement of the token within the designated slot if the data processing system determines that the token satisfies the specific criteria of the slot onto which it is dropped. Additionally, feedback, such as visual, audio, or haptic feedback, can be provided to provide an immediate confirmation of whether the token is eligible for placement in that particular slot. Responsive to selecting one or more content items corresponding to NFTs, each slot will be filled with a respective eligible token.

The data processing system can receive a request to discard a subset of the plurality of non-fungible tokens (STEP 306). In some implementations, the data processing system can present an interactive element (or an actionable object) via the user interface to craft the selected recipe content item. An interaction with the actionable object can cause the data processing system to provide a confirmation user interface in response to determining that each non-fungible token satisfies the respective criteria of a receptive slot, as described herein (STEP 308). In some implementations, upon interacting with the actionable object, the data processing system removes the association of the selected tokens with the player profile. Additionally, the data processing system can update a discard data structure for tracking discarded or burned NFTs. As described herein, the update may involve adding one or more identifiers corresponding to the burned tokens. Upon successful burning, the data processing system updates the storage to reflect the claimed reward of a new NFT and creates a new entry in the storage for the NFT, including its unique identifier, metadata, and any other relevant information. In some implementations, the data processing system can concurrently update the database to reflect the same information about the new NFT and maintain records of all NFTs within the system.

Various operations described herein can be implemented on computer systems. FIG. 4 shows a simplified block diagram of a representative server system 400, client computer system 414, and network 426 usable to implement certain embodiments of the present disclosure. In various embodiments, server system 400 or similar systems can implement services or servers described herein or portions thereof. Client computer system 414 or similar systems can implement clients described herein. The system (e.g., the data processing system 105) and others described herein can be similar to the server system 400.

Server system 400 can have a modular design that incorporates a number of modules 402; while two modules 402 are shown, any number can be provided. Each module 402 can include processing unit(s) 404 and local storage 406.

Processing unit(s) 404 can include a single processor, which can have one or more cores, or multiple processors. In some embodiments, processing unit(s) 404 can include a general-purpose primary processor as well as one or more special-purpose co-processors such as graphics processors, digital signal processors, or the like. In some embodiments, some or all processing units 404 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 404 can execute instructions stored in local storage 406. Any type of processors in any combination can be included in processing unit(s) 404.

Local storage 406 can include volatile storage media (e.g., DRAM, SRAM, SDRAM, or the like) and/or non-volatile storage media (e.g., magnetic or optical disk, flash memory, or the like). Storage media incorporated in local storage 406 can be fixed, removable or upgradeable as desired. Local storage 406 can be physically or logically divided into various subunits such as a system memory, a read-only memory (ROM), and a permanent storage device.

The system memory can be a read-and-write memory device or a volatile read-and-write memory, such as dynamic random-access memory. The system memory can store some or all of the instructions and data that processing unit(s) 404 need at runtime. The ROM can store static data and instructions that are needed by processing unit(s) 404. The permanent storage device can be a non-volatile read-and-write memory device that can store instructions and data even when module 402 is powered down. The term “storage medium” as used herein includes any medium in which data can be stored indefinitely (subject to overwriting, electrical disturbance, power loss, or the like) and does not include carrier waves and transitory electronic signals propagating wirelessly or over wired connections.

In some embodiments, local storage 406 can store one or more software programs to be executed by processing unit(s) 404, such as an operating system and/or programs implementing various server functions such as functions of the data processing system 105 of FIG. 1 or any other system described herein, or any other server(s) associated with the data processing system 105, or any other system described herein.

“Software” refers generally to sequences of instructions that, when executed by processing unit(s) 404 cause server system 400 (or portions thereof) to perform various operations, thus defining one or more specific machine embodiments that execute and perform the operations of the software programs. The instructions can be stored as firmware residing in read-only memory and/or program code stored in non-volatile storage media that can be read into volatile working memory for execution by processing unit(s) 404. Software can be implemented as a single program or a collection of separate programs or program modules that interact as desired. From local storage 406 (or non-local storage described below), processing unit(s) 404 can retrieve program instructions to execute and data to process in order to execute various operations described above.

In some server systems 400, multiple modules 402 can be interconnected via a bus or other interconnect 408, forming a local area network that supports communication between modules 402 and other components of server system 400. Interconnect 408 can be implemented using various technologies including server racks, hubs, routers, etc.

A wide area network (WAN) interface 410 can provide data communication capability between the local area network (interconnect 408) and the network 426, such as the Internet. Technologies can be used, including wired (e.g., Ethernet, IEEE 802.3 standards) and/or wireless technologies (e.g., Wi-Fi, IEEE 802.11 standards).

In some embodiments, local storage 406 is intended to provide working memory for processing unit(s) 404, providing fast access to programs and/or data to be processed while reducing traffic on interconnect 408. Storage for larger quantities of data can be provided on the local area network by one or more mass storage subsystems 412 that can be connected to interconnect 408. Mass storage subsystem 412 can be based on magnetic, optical, semiconductor, or other data storage media. Direct attached storage, storage area networks, network-attached storage, and the like can be used. Any data stores or other collections of data described herein as being produced, consumed, or maintained by a service or server can be stored in mass storage subsystem 412. In some embodiments, additional data storage resources may be accessible via WAN interface 410 (potentially with increased latency).

Server system 400 can operate in response to requests received via WAN interface 410. For example, one of modules 402 can implement a supervisory function and assign discrete tasks to other modules 402 in response to received requests. Work allocation techniques can be used. As requests are processed, results can be returned to the requester via WAN interface 410. Such operation can generally be automated. Further, in some embodiments, WAN interface 410 can connect multiple server systems 400 to each other, providing scalable systems capable of managing high volumes of activity. Techniques for managing server systems and server farms (collections of server systems that cooperate) can be used, including dynamic resource allocation and reallocation.

Server system 400 can interact with various user-owned or user-operated devices via a wide-area network such as the Internet. An example of a user-operated device is shown in FIG. 4 as client computing system 414. Client computing system 414 can be implemented, for example, as a consumer device such as a smartphone, other mobile phone, tablet computer, wearable computing device (e.g., smart watch, eyeglasses), desktop computer, laptop computer, and so on.

For example, client computing system 414 can communicate via WAN interface 410. Client computing system 414 can include computer components such as processing unit(s) 416, storage device 418, network interface 420, user input device 422, and user output device 424. Client computing system 414 can be a computing device implemented in a variety of form factors, such as a desktop computer, laptop computer, tablet computer, smartphone, other mobile computing device, wearable computing device, or the like.

Processing unit(s) 416 and storage device 418 can be similar to processing unit(s) 404 and local storage 406 described above. Suitable devices can be selected based on the demands to be placed on client computing system 414; for example, client computing system 414 can be implemented as a “thin” client with limited processing capability or as a high-powered computing device. Client computing system 414 can be provisioned with program code executable by processing unit(s) 416 to enable various interactions with server system 400 of a message management service such as accessing messages, performing actions on messages, and other interactions described above. Some client computing systems 414 can also interact with a messaging service independently of the message management service.

Network interface 420 can provide a connection to the network 426, such as a wide area network (e.g., the Internet) to which WAN interface 410 of server system 400 is also connected. In various embodiments, network interface 420 can include a wired interface (e.g., Ethernet) and/or a wireless interface implementing various RF data communication standards such as Wi-Fi, Bluetooth, or cellular data network standards (e.g., 3G, 4G, LTE, etc.).

User input device 422 can include any device (or devices) via which a user can provide signals to client computing system 414; client computing system 414 can interpret the signals as indicative of particular user requests or information. In various embodiments, user input device 422 can include any or all of a keyboard, touch pad, touch screen, mouse or other pointing device, scroll wheel, click wheel, dial, button, switch, keypad, microphone, and so on.

User output device 424 can include any device via which client computing system 414 can provide information to a user. For example, user output device 424 can include a display to display images generated by or delivered to client computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments can include a device such as a touchscreen that function as both input and output device. In some embodiments, other user output devices 424 can be provided in addition to or instead of a display. Examples include indicator lights, speakers, tactile “display” devices, printers, and so on.

Some embodiments include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 404 and 416 can provide various functionality for server system 400 and client computing system 414, including any of the functionality described herein as being performed by a server or client, or other functionality associated with message management services.

It will be appreciated that server system 400 and client computing system 414 are illustrative and that variations and modifications are possible. Computer systems used in connection with embodiments of the present disclosure can have other capabilities not specifically described here. Further, while server system 400 and client computing system 414 are described with reference to particular blocks, it is to be understood that these blocks are defined for convenience of description and are not intended to imply a particular physical arrangement of component parts. For instance, different blocks can be but need not be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present disclosure can be realized in a variety of apparatus including electronic devices implemented using any combination of circuitry and software.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, e.g., one or more components of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of these. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The terms “data processing apparatus”, “data processing system”, “client device”, “computing platform”, “computing device”, or “device” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of these. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA or an ASIC.

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a player, implementations of the subject matter described in this specification can be implemented on a computer having a display device, e.g., a CRT (cathode ray tube), plasma, or LCD (liquid crystal display) monitor, for displaying information to the player and a keyboard and a pointing device, e.g., a mouse or a trackball, by which the player can provide input to the computer. Other kinds of devices can be used to provide for interaction with a player as well; for example, feedback provided to the player can include any form of sensory feedback, e.g., visual feedback, auditory feedback, or tactile feedback; and input from the player can be received in any form, including acoustic, speech, or tactile input. In addition, a computer can interact with a player by sending documents to and receiving documents from a device that is used by the player; for example, by sending web pages to a web browser on a player's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a player can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as the gaming system described herein can include clients and servers. For example, the gaming system can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving input from a player interacting with the client device). Data generated at the client device (e.g., a result of an interaction, computation, or any other event or computation) can be received from the client device at the server, and vice-versa.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the gaming system could be a single module, a logic device having one or more processing modules, one or more servers, or part of a search engine.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations, elements, or acts of the systems and methods herein referred to in the singular may also embrace implementations including a plurality of these elements; and any references in plural to any implementation, element, or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description, or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from their characteristics thereof. Although the examples provided may be useful for synchronizing non-fungible token ledgers, the systems and methods described herein may be applied to other environments. The foregoing implementations are illustrative, rather than limiting, of the described systems and methods. The scope of the systems and methods described herein may thus be indicated by the appended claims, rather than the foregoing description, and changes that come within the meaning and range of equivalency of the claims are embraced therein.

1. A system, comprising:
one or more processors coupled to non-transitory memory, the one or more processors configured to:
maintain a plurality of player profiles, a first player profile of the plurality of player profiles comprising a plurality of identifiers of a plurality of non-fungible tokens maintained on a blockchain network;
provide, to a client device associated with the first player profile, a graphical user interface for display comprising a plurality of slots, each of the plurality of slots to accept one non-fungible token corresponding to a respective criterion;
receive, from the client device, a request to discard a subset of the plurality of non-fungible tokens, each non-fungible token of the subset provided for a respective slot of the plurality of slots, wherein each non-fungible token of the subset is selected for inclusion in the request in response to one or more interactions at the graphical user interface;
determine that metadata associated with each non-fungible token of the subset satisfies the respective criterion of the respective slot of the plurality of slots for which the non-fungible token is provided;
responsive to determining that each non-fungible token of the subset satisfies the respective criterion:
store a respective identifier of each non-fungible token of the subset in a discard data structure;
update the metadata associated with each non-fungible token of the subset to indicate that each non-fungible token of the subset is burned on the blockchain network and to remove an association with between each token of the subset and the first player profile, wherein the metadata is stored in a database separate from the blockchain network; and
execute, based on the discard data structure, a batch transfer of the subset of the plurality of non-fungible tokens to a predetermined burn address of the blockchain network to discard the subset of the plurality of non-fungible tokens, the batch transfer executed according to a batch schedule and subsequent to updating the metadata associated with each non-fungible token of the subset.

2-3. (canceled)

4. The system of claim 1, wherein the one or more processors are further configured to execute the batch transfer according to the batch schedule based on determining that a threshold number of non-fungible tokens are identified in the discard data structure.

5. The system of claim 1, wherein the one or more processors are further configured to update the first player profile with an additional association with an additional non-fungible token responsive to determining that each non-fungible token of the subset satisfies the respective criterion.

6. The system of claim 1, wherein the one or more processors are further configured to update the first player profile to remove respective associations with the subset of the plurality of non-fungible tokens.

7. The system of claim 1, wherein the one or more processors are further configured to update the discard data structure with one or more respective second identifiers of one or more second non-fungible tokens identified in a second request received from a second client device.

8. The system of claim 1, wherein the one or more processors are further configured to maintain the metadata for each of the plurality of non-fungible tokens in a storage system.

9. The system of claim 7, wherein the one or more processors are further configured to determine that each non-fungible token of the subset satisfies the respective criterion based on the metadata of the non-fungible token matching the respective criterion.

10. The system of claim 7, wherein the metadata comprises at least one of a rarity value, an edition number, a sport identifier, a team identifier, an athlete identifier, or a time period identifier.

11. A method, comprising:
maintaining, by one or more processors coupled to non-transitory memory, a plurality of player profiles, a first player profile of the plurality of player profiles comprising a plurality of identifiers of a plurality of non-fungible tokens maintained on a blockchain network;
providing, by the one or more processors, to a client device associated with the first player profile, a graphical user interface for display comprising a plurality of slots, each of the plurality of slots having a respective criterion corresponding to a respective criterion;
receiving, by the one or more processors, from the client device, a request to discard a subset of the plurality of non-fungible tokens, each non-fungible token of the subset provided for a respective slot of the plurality of slots, wherein each non-fungible token of the subset is selected for inclusion in the request in response to one or more interactions at the graphical user interface;
determining, by the one or more processors, that metadata associated with each non-fungible token of the subset satisfies the respective criterion of the respective slot of the plurality of slots for which the non-fungible token is provided;
responsive to determining that each non-fungible token of the subset satisfies the respective criterion:
storing, by the one or more processors, a respective identifier each non-fungible token of the subset in a discard data structure;
updating, by the one or more processors, the metadata associated with each non-fungible token of the subset to indicate that each non-fungible token of the subset is burned on the blockchain network and to remove an association with between each token of the subset and the first player profile, wherein the metadata is stored in a database separate from the blockchain network; and
executing, by the one or more processors, based on the discard data structure, a batch transfer of the subset of the plurality of non-fungible tokens to a predetermined burn address of blockchain network to discard the subset of the plurality of non-fungible tokens, the batch transfer executed according to a batch schedule and subsequent to updating the metadata associated with each non-fungible token of the subset.

12-13. (canceled)

14. The method of claim 11, further comprising executing, by the one or more processors, the batch transfer according to the batch schedule determining that a threshold number of non-fungible tokens are identified in the discard data structure.

15. The method of claim 11, further comprising updating, by the one or more processors, the first player profile with an additional association with an additional non-fungible token responsive to determining that each non-fungible token of the subset satisfies the respective criterion of the respective slot.

16. The method of claim 11, further comprising updating, by the one or more processors, the first player profile to remove respective associations with the subset of the plurality of non-fungible tokens.

17. The method of claim 11, further comprising updating, by the one or more processors, the discard data structure with one or more respective second identifiers of one or more second non-fungible tokens identified in a second request received from a second client device.

18. The method of claim 11, further comprising maintaining, by the one or more processors, the metadata for each of the plurality of non-fungible tokens in a storage system.

19. The method of claim 17, further comprising determining, by the one or more processors, that each non-fungible token of the subset satisfies the respective criterion based on the metadata of the non-fungible token matching the respective criterion.

20. The method of claim 17, wherein the metadata comprises at least one of a rarity value, an edition number, a sport identifier, a team identifier, an athlete identifier, or a time period identifier.
